(19) United States
(12) Patent Application Publication
(10) Pub. No.: US 2009/0098032 A1
(43) Pub. Date: Apr. 16, 2009

(54) METHODS OF MAKING ALUMINOSILICATE COATED ALUMINA

(75) Inventors: Xiaolin Yang, Edison, NJ (US); Robert Ianniello, Parlin, NJ (US)

Correspondence Address: BASF CATALYSTS LLC, 100 CAMPUS DRIVE, FLORHAM PARK, NJ, 07932, US

(73) Assignee: BASF CATALYSTS LLC, Florham Park, NJ (US)

(21) Appl. No.: 11/870,669

(22) Filed: Oct. 11, 2007

(51) Int. Cl. B01J 21/04; B01D 53/56; B05D 3/00; B01D 53/62

(52) U.S. Cl. 423/213.2; 423/210; 423/239.1; 427/372.2; 502/263

(57) ABSTRACT

An aluminosilicate coated alumina structure that is substantially free of alkaline metal impurities contains an aluminosilicate coating at least partially surrounding an alumina core. The aluminosilicate coated alumina structure is useful as a catalyst or catalyst support.

### TECHNICAL FIELD

Disclosed are methods of making aluminosilicate coated alumina structures and methods of using the aluminosilicate coated alumina structures in the field of catalysis.

### BACKGROUND

A catalyst increases the rate of a chemical reaction. The catalyst is itself not consumed by the overall chemical reaction. A catalyst provides an alternative route of reaction where the activation energy is lower than the corresponding uncatalyzed chemical reaction.

Catalysts and catalyst supports have various limitations and drawbacks. For example, any given catalyst may have, lack, or need attrition resistance, high temperature resistance, acid resistance, steam resistance, sulfur resistance, and the like. Obtaining a catalyst with many desirable characteristics is in some instances difficult to obtain.

Silica doped alumina has been used extensively as a catalyst carrier, and in fewer instances as a catalyst. Various methods are known for making silicon doped alumina, such as extrusion and hydrolysis, impregnation, and precipitation.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

The subject invention provides aluminosilicate coated alumina structures useful in catalysis. The aluminosilicate coated alumina structures can be used as catalysts or as catalyst supports. The aluminosilicate coated alumina structures are substantially free of alkaline metal impurities and have high thermal stability.

One aspect of the invention relates to methods of making an aluminosilicate coated alumina structure substantially free of alkaline metal impurities involving contacting an alumina precursor with a silicon precursor in an aqueous solvent to form a mixture, drying the mixture, and heating the mixture to provide the aluminosilicate coated alumina structure.

Another aspect of the invention relates to an aluminosilicate coated alumina structure that is substantially free of alkaline metal impurities contains an aluminosilicate coating at least partially surrounding an alumina core. Yet another aspect of the invention relates to method of treating exhaust gas involving contacting the exhaust gas with a catalyst which uses the aluminosilicate coated alumina structure as a catalyst carrier.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF SUMMARY OF THE DRAWINGS

FIG. 1 is a Transmission Electron Microscopy (TEM) image of an aluminosilicate coated alumina structure in accordance with one aspect of the invention.

FIG. 2 is a comparative TEM image of a conventional silica-doped alumina in which silica ball-like structures surrounding alumina.

FIG. 3 is a graphical representation comparing pore size and distribution of an aluminosilicate coated alumina structure in accordance with one aspect of the invention and a comparative silica-doped alumina structure.

FIG. 4 depicts Si-29 Nuclear Magnetic Resonance (NMR) spectra for aluminosilicate coated alumina structure and comparative silica-doped alumina structure in accordance with one aspect of the invention.

### DETAILED DESCRIPTION

Methods of making the aluminosilicate coated alumina generally involve the impregnation of a silicon precursor in water on a porous hydrated or active alumina precursor, followed by drying and calcination. The aqueous process, without using colloidal silica, sodium silicate solution (water glass), or an ion-exchanger, offers an alternative to the conventional processes and is practical and feasible for large-scale commercial manufacturing.

The aluminosilicate coated alumina can be used as catalyst and/or catalyst carrier largely due to its increased thermal stability and sulfur tolerance as compared to pure alumina. These two properties in particular are highly desirable for a large number of industry processes that handle sulfur-containing feeds at high temperature and in the presence of water vapor, such as diesel oxidation catalysts in diesel-burning vehicles. The aluminosilicate coated alumina described herein presents a high performance alternative to silica coated alumina and alumina, and thus is important for both economic and utility purposes.

While not wishing to be bound by any theory, it is believed that the silicon atoms in the aluminosilicate coated alumina are chemically bonded to aluminum atoms via oxygen atom bridges and thus stabilize the pore structure of the bottom layer of alumina and improve the overall catalytic performance and other properties of structures that do not have substantially uniform aluminosilicate structures. In order to improve and/or maximize the stabilization affect of silicon incorporation, two conditions achieved. First, silicon is reacted chemically with alumina in the coating such that no separated silica phase exists. In other words, an aluminosilicate layer is formed on the surface of alumina. Second, no impurity, especially alkaline metal ions, is allowed to be introduced since impurities substantially compromise the effectiveness of the materials (as either catalysts or catalyst carriers).

The aluminosilicate coated alumina is formed by three acts. First, an alumina precursor is contacted with a silicon precursor. The mixture is then dried. After drying, the mixture is heated to provide the aluminosilicate coated alumina. Other additional acts may be optionally performed to optimize the aluminosilicate coated alumina for a particular desired end use and/or to improve certain properties of the aluminosilicate coated alumina.

The alumina precursor is a material that can be converted to alumina by heating, and has a structure that facilitates formation of a uniform aluminosilicate coating on alumina. The presence of surface hydroxyl groups in the alumina precursor can in some instances promote the chemical reaction between the silicon precursor and the alumina precursor. Examples of alumina precursors include boehmite, psuedo-bohmite, gibbsite, bayerite, flash calcined gibbsite, aluminum alkoxides, and activated aluminas such as gamma alumina and the like.

The alumina precursor has a suitable surface area to facilitate formation of a uniform aluminosilicate coating on alumina. In one embodiment, the alumina precursor has a BET surface area from about 100 m²/g to about 500 m²/g. In another embodiment, the alumina precursor has a BET surface area from about 150 m²/g to about 450 m²/g. In yet another embodiment, the alumina precursor has a BET surface area from about 200 m²/g to about 400 m²/g. The surface areas, pore volumes, and average pore diameters reported herein are determined using a standard nitrogen adsorption method.

The alumina precursor has a suitable pore volume to facilitate formation of a uniform aluminosilicate coating on alumina. In one embodiment, the alumina precursor has a pore volume from about 0.2 cc/g to about 1 cc/g. In another embodiment, the alumina precursor has a pore volume from about 0.25 cc/g to about 0.9 cc/g. In another embodiment, the alumina precursor has a pore volume from about 0.3 cc/g to about 0.8 cc/g.

The alumina precursor has a suitable average pore diameter to facilitate formation of a uniform aluminosilicate coating on alumina. In one embodiment, the alumina precursor has an average pore diameter from about 1 nm to about 25 nm. In another embodiment, the alumina precursor has an average pore diameter from about 2 nm to about 20 nm. In yet another embodiment, the alumina precursor has an average pore diameter from about 3 nm to about 15 nm.

The alumina precursor can be in any physical forms such as powder, granules, pellets, and other extruded forms.

Alumina precursors are commercially available or can be made. Examples of commercially available alumina precursors include those under the trade designations PURAL®, CATAPAL®, PURALOX®, and CATALOX® aluminas available from Sasol; various aluminas and activated aluminas such as G250 available from BASF. Alternatively, alumina precursors can be made by the precipitation of sodium aluminate and aluminum sulfate. This precipitation product can be crystallized, washed, and/or dried.

The silicon precursor is a material that can be converted to aluminosilicate by heating with an alumina. General examples of silicon precursors include alkylorthosilicates and silicic acids. In one embodiment, the silicon precursor is an organic silicon precursor. Specific examples of alkylorthosilicate silicon precursors include tetramethylorthosilicate Si(OMe)₄, tetraethylorthosilicate (TEOS) Si(OEt)₄, tetrapropylorthosilicate, and the like. Alkylsilicates have the general formula Si(OR)₄, wherein each R is independently a straight-chain, branched-chain or cyclic alkyl or alkenyl group having 1 to about 10 carbon atoms, which optionally have one or more carbonyl and/or ester and/or carboxyl functions. Specific examples of silicic acid include metasilicic acid (H₂SiO₃), orthosilicic acid (H₄SiO₄), disilicic acid (H₂Si₂O₅), and pyrosilicic acid (H₆Si₂O₇). In one embodiment, however, the silicon precursor is not silicic acid (including orthosilicic acid).

The alumina precursor and the silicon precursor can be contacted in any suitable manner such as in an aqueous solvent. Examples of aqueous solvents include water and optionally one or more of alcohols including lower alcohols, lower glycols, ketones including lower ketones, acids including inorganic acid solutions and organic acids, and esters including lower esters. Specific examples of solvents include water and water-alcohol combinations.

One unexpected finding associated with the methods described herein is the relatively high stability of the silicon precursor, such as TEOS, in aqueous systems. This is contrary to beliefs that compounds such as TEOS hydrolyze upon contact with water. However, silicon precursors, such as TEOS, are actually suitably stable in water at the ambient conditions for a sufficiently long period of time, e.g., longer than a few hours, for making the aluminosilicate coated alumina structures. Consequently, impregnation of the TEOS/water mixture on an aluminum precursor surface without premature hydrolysis of TEOS is possible in accordance with the invention.

Another unexpected finding associated with the methods described herein is that, even in instances when the silicon precursor and water are not miscible, the silicon precursor can be dispersed uniformly on the alumina precursor substrate by a rigorous stirring the mixture during the impregnation act. The silicon precursor is suitably reactive with the alumina precursor surface at elevated temperatures to form in situ a uniform aluminosilicate coating on the bulk alumina.

Optionally, a surfactant may be added to the aqueous solvent to facilitate dispersal of the silicon precursor. Any type of surfactant may be employed, including ionic, nonionic, cationic, anionic, and amphoteric surfactants. Surfactants are known in the art, and many surfactants are described in McCutcheon's “Volume I: Emulsifiers and Detergents”, 2001, North American Edition, published by McCutcheon's Division MCP Publishing Corp., Glen Rock, N.J., and in particular, pp. 1-233 which describes a number of surfactants and is hereby incorporated by reference for the disclosure in this regard. In one embodiment, a surfactant is employed when the aqueous solvent contains water. In another embodiment, a surfactant is not included in the aqueous solvent.

After impregnating the silicon precursor on the alumina precursor, the wet paste mixture is dried. Drying involves one or more of desiccating, light heating, and contact with a vacuum. In one embodiment, the mixture of the alumina precursor and the silicon precursor is dried at a temperature from about 25° C. to about 150° C. for a time from about 1 hour to about 25 hours. In another embodiment, the mixture of the alumina precursor and the silicon precursor is dried at a temperature from about 40° C. to about 105° C. for a time from about 2 hours to about 15 hours.

The mixture of the alumina precursor and the silicon precursor is then heated at a suitable heating rate to a temperature and hold at the temperature for a suitable time to provide an aluminosilicate coating at least partially surrounding an alumina core. When the alumina precursor is in hydrated form, such as boehmite or pseudo-boehmite, the heating transforms the rest of the alumina precursor into an active alumina such as gamma alumina. In one embodiment, the mixture of the alumina precursor and the silicon precursor is heated at a temperature from about 400° C. to about 900° C. for a time from about 10 minutes to about 5 hours. In another embodiment, the mixture of the alumina precursor and the silicon precursor is heated at a temperature from about 450° C. to about 850° C. for a time from about 20 minutes to about 4 hours. In yet another embodiment, the mixture of the alumina precursor and the silicon precursor is heated at a temperature from about 500° C. to about 800° C. for a time from about 30 minutes to about 3 hours.

In one embodiment, the methods of making the aluminosilicate coated alumina do not comprise using colloidal silica. In another embodiment, the methods of making the aluminosilicate coated alumina do not comprise using sodium silicate solution (water glass). In yet another embodiment, the methods of making the aluminosilicate coated alumina do not comprise using an ion-exchanger.

The resultant aluminosilicate coated alumina is substantially free of alkaline metal impurities, such as sodium. Alkaline metal impurities often detrimentally reduce the pore structure of the alumina and deleteriously interfere with subsequent catalytic processes in which an alumina based catalyst may be involved; thus, the lack of alkaline metal impurities improves the performance of the aluminosilicate coated alumina described herein. By substantially free of alkaline metal impurities, the aluminosilicate coated alumina contains less than about 5 ppm of alkaline metal impurities when a Na-free alumina precursor is used. In another embodiment, the aluminosilicate coated alumina contains less than about 800 ppm of alkaline metal impurities when a low-Na, low cost alumina precursor is used.

The aluminosilicate coated alumina has a suitable surface area to facilitate catalytic activity. In one embodiment, the aluminosilicate coated alumina has a surface area from about 100 m²/g to about 600 m²/g. In another embodiment, the aluminosilicate coated alumina has a surface area from about 175 m²/g to about 500 m²/g. In yet another embodiment, the aluminosilicate coated alumina has a surface area from about 200 m²/g to about 400 m²/g.

The aluminosilicate coated alumina has a suitable pore volume to facilitate catalytic activity. In one embodiment, the aluminosilicate coated alumina has a pore volume from about 0.2 cc/g to about 1.5 cc/g. In another embodiment, the aluminosilicate coated alumina has a pore volume from about 0.35 cc/g to about 1.4 cc/g. In yet another embodiment, the aluminosilicate coated alumina has a pore volume from about 0.4 cc/g to about 1.2 cc/g.

The aluminosilicate coated alumina has a suitable average pore diameter to facilitate one or more of catalytic activity, high thermal stability, and a high degree of sulfur resistance. In one embodiment, the aluminosilicate coated alumina has an average pore diameter from about 1 nm to about 25 nm. In another embodiment, the aluminosilicate coated alumina has an average pore diameter from about 2 nm to about 20 nm. In yet another embodiment, the aluminosilicate coated alumina has an average pore diameter from about 3 nm to about 15 nm.

The aluminosilicate coated alumina has an aluminosilicate coating at least partially surrounding an alumina core. That is, at least about 75% of the silicon is in the structure of the aluminosilicate coating thereon. In another embodiment, at least about 90% of the silicon is in the structure of the aluminosilicate coating thereon. In yet another embodiment, substantially all of the silicon is in the form of the aluminosilicate coating thereon. In one embodiment, the aluminosilicate coating has an average thickness surrounding the alumina core (thickness where present) from about 0.1 nm to about 20 nm. In another embodiment, the aluminosilicate coating has an average thickness surrounding the alumina core from about 0.1 nm to about 10 nm.

The aluminosilicate coated alumina has a suitable silica content to provide one or more of catalytic activity, high thermal stability, and a high degree of sulfur resistance. In one embodiment, the aluminosilicate coated alumina has a silica content from about 0.25% to about 20% by weight. In another embodiment, the aluminosilicate coated alumina has a silica content from about 0.5% to about 15% by weight. In yet another embodiment, the aluminosilicate coated alumina has a silica content from about 1% to about 10% by weight. The amount of silica in the aluminosilicate coated alumina can be determined using ICP elemental analysis.

The aluminosilicate coated alumina has a high thermal stability. The high thermal stability contributes to particular usefulness in high temperature catalytic operations. Also, the high thermal stability contributes to ease of use with high temperature components such as water vapor. For example, after thermal aging (heating at 1150° C. for 4 hours), the thermally aged aluminosilicate coated alumina has a surface area from about 5 m²/g to about 200 m²/g, a pore volume from about 0.2 cc/g to about 1 cc/g, and an average pore diameter from about 5 nm to about 100 nm. In another embodiment, the thermally aged aluminosilicate coated alumina has a surface area from about 15 m²/g to about 100 m²/g, a pore volume from about 0.25 cc/g to about 0.75 cc/g, and an average pore diameter from about 10 nm to about 75 nm.

The aluminosilicate coated alumina has a high degree of sulfur resistance. The high degree of sulfur resistance contributes to particular usefulness in catalytic operations involving a sulfur containing feed(s), including those feeds with either a high level of sulfur or a low level of sulfur.

The aluminosilicate coated alumina has silicon atoms fully and uniformly dispersed in the coating portion. The uniform dispersement of the silicon atoms means that there is substantially no separated silica phase. In other words, the aluminosilicate coating is directly formed on the surface of the alumina core.

The aluminosilicate coated alumina is useful as a catalyst or as a catalyst support in applications including one or more of exhaust catalysts for internal combustion engines including diesel oxidation catalysts; oxidation catalysts; NOx reduction catalysts; hydrogenation catalysts; dehydrogenation catalysts; steam reforming catalyst, water-gas-shift catalysts, Fischer-Tropsch gas-to-liquid conversion catalysts, fluid cracking catalysts; polymerization catalysts; isomerization catalysts; purification catalysts; dehydration catalysts; reduction catalysts; dehydrocyclization catalysts; hydroformylation catalysts; hydrohalogenation catalysts, hydrocracking catalysts; and the like. Thus, the aluminosilicate coated alumina is useful in catalytic methods corresponding to any the above-mentioned catalysts.

In embodiments where the aluminosilicate coated alumina functions at least in part as a catalyst support, one or more catalytically active metals may be applied the aluminosilicate coated alumina. Examples of catalytically active metals and their various combinations thereof include platinum, palladium, rhodium, iridium, ruthenium, osmium, rhenium, copper, silver, gold, cobalt, nickel, iron, vanadium, chromium, manganese, tungsten, tin, lead, and germanium etc. It is to be understood that the aforementioned list of catalytically active metals are only representative, and thus not limiting of the type of metals with which the aluminosilicate coated alumina support may be impregnated. One advantage of the present aqueous process is that it allows the incorporation of an active metal in the aluminosilicate coated alumina system by dissolving the active metal precursor in the aqueous phase before the impregnation act.

Methods of treating exhaust gas, such as diesel exhaust gas, involve contacting the exhaust gas with a catalyst that uses the aluminosilicate coated alumina as the catalyst carrier. Internal combustion engine exhaust streams/gas in general and diesel engine exhaust streams/gas in particular typically contain one or more of nitrogen oxides, carbon monoxide, gaseous hydrocarbons, and particulate matter. The aluminosilicate coated alumina structure may or may not be impregnated with one or more catalytically active metals, and may be in the form of a flowthrough, foam or mesh substrate. For example, the aluminosilicate coated alumina structure may be in the form of a flowthrough carrier having a plurality of exhaust flow passages extending therethrough. The aluminosilicate coated alumina structure may be in the form of a filter. Examples of filter structures include wallflow filters; foam filters; wound fiber filters; ceramic fiber felt, knit or weave filters; and mesh filters.

In one embodiment, when the aluminosilicate coated alumina is used as an oxidation catalyst or oxidation catalyst support, the aluminosilicate coated alumina can be used by itself or as a catalyst carrier to treat engine exhaust gas. The aluminosilicate coated alumina oxidation catalyst treat the exhaust gas by converting either or both hydrocarbon and CO gaseous pollutants and particulates to carbon dioxide and/or water while reducing NOx to N₂—.

The following examples illustrate the subject invention. Unless otherwise indicated in the following examples and elsewhere in the specification and claims, all parts and percentages are by weight, all temperatures are in degrees Centigrade, and pressure is at or near atmospheric pressure.

### EXAMPLE 1

Example 1 describes the preparation of aluminosilicate coated alumina, dubbed as ASCA, using pseudo-boehmite CATAPAL® B. Eight samples are made using varying amounts of TEOS and ethanol.

1. mix TEOS (Aldrich, 98%) with ethanol (Alfa Aesar, anhydrous, reagent grade),
2. impregnate above solution drop-wise IN CATAPAL® B, a commercial product from Sasol,
3. dry the paste at about 40-70° C. overnight to slowly drive off the alcohol; recover the alcohol vapor for recycle, and
4. heat up the solid in air to 600° C. and hold for 2 hours. The resulting materials are coded as ASCA-CB-Si.

Table 1 lists the weight of each ingredient used for the samples containing different levels of silicon. Also listed in Table 1 are the ICP elemental analysis data of the silicon content of the calcined products.

TABLE 1
Raw materials and final silicon content of ASCA-CB-Si products

| Sample | Catapal B(g) | TEOS(g) | Ethanol(g) | % SiO₂ (as is basis) |
|---|---|---|---|---|
| 1-1 | 25 | 0 | 0 | 0 |
| 1-2 | 25 | 0.70 | 11.87 | 0.4 |
| 1-3 | 25 | 1.42 | 10.60 | 1.5 |
| 1-4 | 25 | 2.12 | 9.88 | 2.5 |
| 1-5 | 25 | 2.89 | 9.13 | 3.5 |
| 1-6 | 25 | 3.66 | 8.37 | 4.4 |
| 1-7 | 25 | 5.62 | 6.39 | 6.9 |
| 1-8 | 25 | 7.71 | 4.31 | 8.8 |

Table 2 lists the porosity data of the eight ASCA-CB-Si samples. The porosity was measured by the standard N₂ adsorption method which yields surface area (BET), pore volume (PV) and average pore diameter (PD). To demonstrate the enhancement of thermal stability by the silicon incorporation, the ASCA-CB-Si samples in Table 1 were thermally aged at 1150° C. in air for 4 hours. N₂ adsorption data was obtained on a Micromeritics ASAP2400 system. The samples were heated at 250° C. under vacuum for at least 6 hours before the analysis. The surface area was calculated by the Brunauer-Emmett-Teller (BET) method with 39 relative pressure points. The pore volume represents the total pore volume of pores with a pore radius between 10 and 300 Å, using the BJH desorption cumulative pore volume method. The average pore diameter was calculated based on the following equation:

PD=4(PV)/A

where A is the BJH desorption cumulative surface area of pores between 10 and 300 Å radius. The porosity data of the aged samples is also listed in Table 2.

TABLE 2
N₂ porosity data of ASCA-CB-Si and aged samples at 1150° C.

| | | BET (m²/g) | | PV (cc/g) | | PD (nm) | |
|---|---|---|---|---|---|---|---|
| Sample | SiO₂ (%) | 600° C. | 1150° C. | 600° C. | 1150° C. | 600° C. | 1150° C. |
| 1-1 | 0 | 203 | 6 | 0.50 | 0.02 | 6.0 | 24.0 |
| 1-2 | 0.4 | 248 | 26 | 0.45 | 0.17 | 5.7 | 20.8 |
| 1-3 | 1.5 | 270 | 56 | 0.45 | 0.20 | 5.3 | 10.9 |
| 1-4 | 2.5 | 274 | 70 | 0.43 | 0.24 | 5.2 | 9.8 |
| 1-5 | 3.5 | 287 | 77 | 0.43 | 0.25 | 5.1 | 9.5 |
| 1-6 | 4.4 | 293 | 80 | 0.424 | 0.26 | 4.9 | 9.2 |
| 1-7 | 6.9 | 296 | 84 | 0.40 | 0.26 | 4.7 | 8.5 |
| 1-8 | 8.8 | 299 | 95 | 0.39 | 0.27 | 4.6 | 7.7 |

The BET surface area data shows that the incorporation of silicon in alumina slightly increased the surface area at 600° C., but significantly stabilized the alumina evidenced by much higher surface area survived at 1150° C. At a silicon content of about 8.8% of SiO₂, the stabilization effect is still not peaked yet. On the other hand, two factors control the pore volume. At low calcination temperatures, the pore volume and pore size decrease as the silicon content increases because more silicon gets into the pores of alumina and forms an aluminosilicate coating wall. The pore volume and pore size are controlled mainly by the thickness of the aluminosilicate coating. After high temperature aging, the pore volume increases while the pore size decreases as silicon is incorporated into the alumina structure. This clearly shows the stabilization of the alumina pore structure at high temperatures because of the formation of the aluminosilicate coating.

### EXAMPLE 2

Example 2 describes the preparation of ASCA using pseudo-boehmite G250, a commercial pseudo-boehmite product of BASF. Various chemical and physical properties of G250 are listed in Table 3. For comparison, the data for CATAPAL® B is also listed in Table 3.

TABLE 3
Chemical and physical properties of GA250 and CATAPAL ® B

| | G250 | CATAPAL ® B |
|---|---|---|
| Na₂O, % | 0.08 | <0.01 |
| MgO, % | 0.23 | <0.01 |
| LOI, % | 28 | 27 |
| BET (m²/g) | 362 | 294 |
| PV(cc/g) | 0.66 | 0.36 |
| PD(nm) | 6.0 | 3.9 |

The aluminosilicate-coating of G250 using TEOS in this work follows the same protocols as in Example 1. The final products are coded as ASCA-GA-Si. Table 4 lists the porosity data of ASCA-GA-Si samples and their thermally aged products, together with the silica content measured by ICP.

TABLE 4
N₂ porosity data of ASCA-GA-Si and aged samples at 1150° C.

| | | BET (m²/g) | | PV (cc/g) | | PD (nm) | |
|---|---|---|---|---|---|---|---|
| Sample | SiO2 (%) | 600° C. | 1150° C. | 600° C. | 1150° C. | 600° C. | 1150° C. |
| 2-1 | 0 | 249 | 14 | 0.74 | 0.07 | 9.4 | 26 |
| 2-2 | 0.6 | 267 | 54 | 0.72 | 0.32 | 8.6 | 18.5 |
| 2-3 | 2.7 | 299 | 83 | 0.71 | 0.43 | 7.0 | 16.4 |
| 2-4 | 4.6 | 298 | 89 | 0.66 | 0.46 | 6.9 | 15.9 |
| 2-5 | 6.8 | 324 | 99 | 0.66 | 0.47 | 6.6 | 14.9 |
| 2-6 | 9.7 | 318 | 104 | 0.63 | 0.46 | 6.4 | 13.4 |

Similarly as ASCA-CB-Si, the surface area data of ASCA-GA-Si shows that the incorporation of silicon slightly increased the surface area at 600° C., but significantly stabilized the alumina evidenced by much higher surface area survived at 1150° C. At a silicon content of about 9.7% of SiO₂, the stabilization effect does not appear to have peaked yet. The pore volume and pore size data shows that silicon incorporation increases the pore volume and reduces the overall pore size by thickening the wall of the pore and stabilizing the structure.

### EXAMPLE 3

Example 3 describes the preparation of ASCA-GA-Si using an aqueous process. One requirement of the TEOS impregnation strategy described in Examples 1 and 2 is that an organic solvent is used to disperse TEOS. Example 3 describes an aqueous process to make ASCA using TEOS which is dispersed in a mixture of water and surfactant.

The preparation of ASCA-GA-Si via an aqueous process follows the same protocols as in Example 2 except that ethanol was replaced by cetyltrimethylammonium chloride aqueous solution (20%) which was obtained from Aldrich. Table 5 compares the porosity data of the aged ASCA-GA-Si samples from the two processes, together with the silica content measured by ICP.

TABLE 5
N₂ porosity data of ASCA-GA-Si aged at 1150° C.

| SiO₂ (%) | | BET (m²/g) | | PV (cc/g) | | PD (nm) | |
|---|---|---|---|---|---|---|---|
| Aque | Non-Aq | Aque | Non-Aq | Aque | Non-Aq | Aque | Non-Aq |
| 2.2 | 2.7 | 81 | 83 | 0.46 | 0.43 | 17.8 | 16.4 |
| 4.0 | 4.6 | 93 | 89 | 0.48 | 0.46 | 16.6 | 15.9 |
| 7.5 | 9.7 | 106 | 104 | 0.49 | 0.46 | 14.5 | 13.4 |

Overall, the stability of ASCA-GA-Si obtained from the aqueous process is slightly better than those from the non-aqueous process, evidenced by the higher BET surface area and pore volume. Notice in Table 5 that the silicon content of the non-aqueous samples is actually higher than the aqueous samples. In other words, using the same silicon loading, the aqueous method should yield a product with even higher thermal stability.

### EXAMPLE 4

Example 4 describes the preparation of aluminosilicate coated alumina using a surfactant-free, aqueous process. In Example 3, an aqueous process of synthesizing aluminosilicate coated alumina using TEOS which was dispersed in a mixture of water and surfactant is described. In Example 4, the aqueous process is modified by removing the use of the surfactant, which in some instances makes the synthesis simpler and more economic.

The surfactant-free aqueous process is performed by mixing TEOS and water directly, and then dispersing the mixture onto the pseudo boehmite substrate, followed by drying and calcination. Since TEOS is not soluble in water, in order to make the TEOS dispersion uniform, the following two methods were developed.

Method 1 (referred as 2-acts): wet 20.0 g pseudo-boehmite (G250) partially with 10.7 g water by incipient wetness, then complete the full wetness of the pseudo-boehmite by adding 7.71 g TEOS drop-wise while stirring the solid.

Method 2 (referred as 1-act): put 7.71 TEOS and 10.7 water together (the solution has two layers); add the mixture drop-wise to 20.0 g of G250 (incipient wetness) while agitating the mixture rigorously with an air stream or a physical stirrer.

After being dried at 80° C. overnight, calcined at 550° C. for 2 hours, and aged at 1150° C. for 4 hours, the aluminosilicate coated alumina shows excellent thermal stability as measured by N₂ adsorption properties and summarized in Table 6.

TABLE 6
N₂ porosity data of ASCA-GA-Si aged at 1150° C.

| | Process | | |
|---|---|---|---|
| Properties | w/surfactant | w/o surfactant/2-acts | w/o surfactant/1-act |
| SiO₂ (%) | 7.5 | 7.5 | 8.8 |
| BET, m₂/g | 106 | 105 | 107 |
| PV (cc/g) | 0.494 | 0.44 | 0.454 |
| PD (nm) | 14.5 | 12.6 | 12.8 |

Although all three aqueous methods yielded similar porosity, the surfactant-free, 1-act method is particularly advantageous since it gives the material with the lowest TEOS loss during drying and the simplest operation procedure.

### EXAMPLE 5

Example 5 describes the preparation of a conventional silica-coated alumina and its comparison with the aluminosilicate coated alumina. The conventional silica-coated alumina is prepared by the same method given in Example 1 except a colloidal silica (Ludox® AS-40 from Aldrich) is used as the silicon precursor and CATAPAL® C is used as the alumina precursor. The N₂ porosity data of the two comparative samples, both contain about 3% silica and thermally aged at 1150° C. for 4 hours, is listed in Table 7.

TABLE 7
Comparison of porosity of Si-containing alumina products after
thermal aging at 1150° C.

| | Silicon | BET | PV | PD |
|---|---|---|---|---|
| Sample | precursor | m²/g | cc/g | nm |
| ASCA-CC-Si3 | TEOS | 80 | 0.31 | 11.6 |
| Silica-doped alumina | colloidal silica | 36 | 0.20 | 17.3 |

As shown in Table 7, the surface area and pore volume of the thermally aged ASCA-CC-3Si is significantly higher than the comparative silica-coated alumina. The pore size of ASCA-CC-Si3 is also significantly smaller due to the aluminosilicate coating. The superiority of aluminosilicate coated alumina in accordance with the invention, over conventional silica-doped alumina is further evidenced by a number of additional observations.

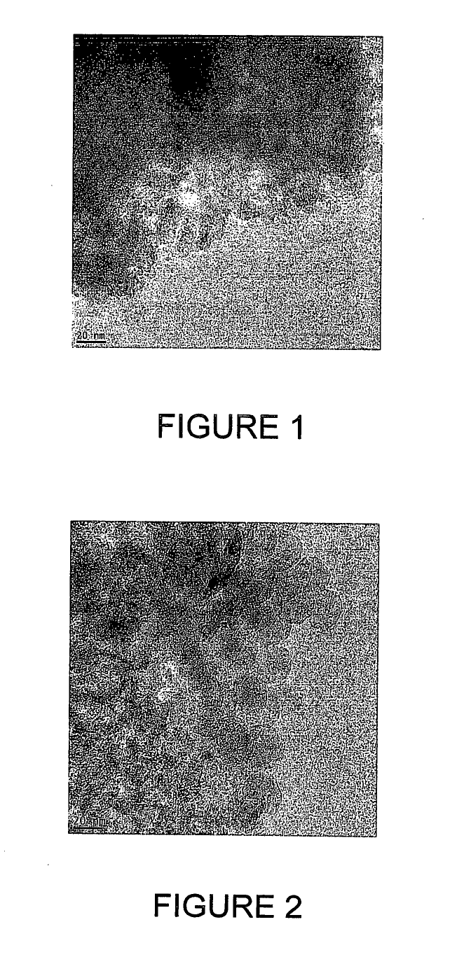

First, under high resolution transmission electron microscope, only a homogenous surface was found in ASCA-CC-Si (FIG. 1) while separated silica balls of about 20 nm diameter size can be clearly seen on alumina surface in the silica-doped alumina sample (FIG. 2).

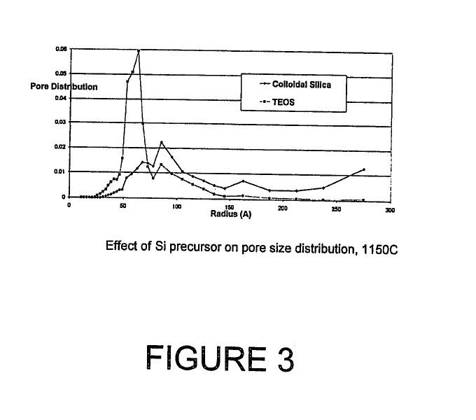

Second, after thermal aging at 1150° C., the N₂ pore distribution of ASCA-CC-Si still shows a single pore system centered at about 6.0 nm. For the silica-doped alumina sample, in addition to the main pore system with center shifted to about 7.5 nm, more than one pore systems were developed at a much larger pore size, which is likely due to the separated silica phase, shown in the plot below in FIG. 3.

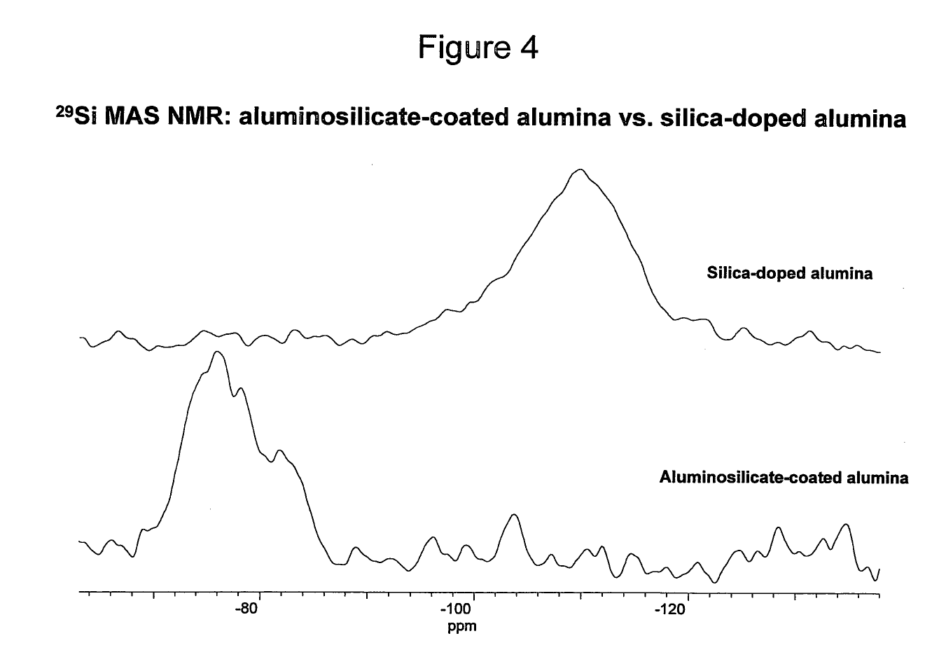

Perhaps the most direct evidence of the formation of aluminosilicate structure in ASCA-CC-Si comes from 29Si Magic-Angel Spinning (MAS) NMR spectroscopy. As shown in the NMR spectra below in FIG. 4, the main resonance peak of ASCA-CC-Si is located at about −78 ppm, indicating the formation of the chemical bonding of Si—O—Al. On the other hand, the main resonance peak of the silica-doped alumina is at about −110 ppm, a typical location of a silica structure where a silicon atom is surrounded by four other silicon atoms via oxygen bridges. A detailed description of Si NMR spectroscopy and the peak assignment for silicate materials is given in Gunter Engelhardt and Dieter Michel's “High-Resolution Solid-State NMR of Silicates and Zeolites”, 1987, published by John Wiley & Sons and is hereby incorporated by reference for the disclosure in this regard.

With respect to any figure or numerical range for a given characteristic, a figure or a parameter from one range may be combined with another figure or a parameter from a different range for the same characteristic to generate a numerical range.

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A method of making an aluminosilicate coated alumina structure substantially free of alkaline metal impurities, comprising:
contacting an alumina precursor with a silicon precursor in an aqueous solvent to form a mixture;
drying the mixture at a temperature from about 25° C. to about 150° C. for a time from about 1 hour to about 25 hours; and
heating the mixture at a temperature from about 400° C. to about 900° C. to provide the aluminosilicate coated alumina comprising less than 800 ppm alkaline metal impurities.

2. The method of claim 1, wherein the mixture is heated at a temperature from about 400° C. to about 900° C. for a time from about 10 minutes to about 5 hours.

3. The method of claim 1, wherein the alumina precursor is selected from the group consisting of boehmite, psuedo-bohmite, gibbsite, bayerite, flash calcined gibbsite, aluminum alkoxides, and active aluminas including gamma alumina.

4. The method of claim 1, wherein the alumina precursor has a surface area from about 100 m²/g to about 500 m²/g, a pore volume from about 0.2 cc/g to about 1 cc/g, and an average pore diameter from about 1 nm to about 25 nm.

5. The method of claim 1, wherein the silicon precursor is selected from the group consisting of alkylorthosilicates, silicon alcoholates, and silicic acids.

6. The method of claim 1, wherein the aqueous solvent comprises one selected from the group consisting of a mixture of water and alcohols, lower glycols, ketones, inorganic acid solutions, organic acids solutions, and esters.

7. The method of claim 1 further comprising adding a surfactant to the solvent.

8. The method of claim 1, wherein the aqueous solvent consists essentially of water.

9. A method of making an aluminosilicate coated alumina structure substantially free of alkaline metal impurities, comprising:
contacting an alumina precursor with an alkylorthosilicate in water to form a mixture;
drying the mixture at a temperature from about 25° C. to about 150° C. for a time from about 1 hour to about 25 hours; and
heating the mixture at a temperature from about 400° C. to about 900° C. to provide the aluminosilicate coated alumina comprising less than 800 ppm alkaline metal impurities.

10. The method of claim 9, wherein the mixture is heated at a temperature from about 400° C. to about 900° C. for a time from about 10 minutes to about 5 hours.

11. The method of claim 9, wherein the alumina precursor is selected from the group consisting of boehmite, psuedo-bohmite, gibbsite, bayerite, flash calcined gibbsite, aluminum alkoxides, and active aluminas including gamma-alumina.

12. The method of claim 9, wherein the alumina precursor has a surface area from about 100 m²/g to about 500 m²/g, a pore volume from about 0.2 cc/g to about 1 cc/g, and an average pore diameter from about 1 nm to about 25 nm.

13. The method of claim 9, wherein the alkylorthosilicate comprises tetraethylorthosilicate.

14. The method of claim 9, wherein the alumina precursor has a form of a powder, granule, and pellet.

15. An aluminosilicate coated alumina structure substantially free of alkaline metal impurities, comprising:
an aluminosilicate coating at least partially surrounding an alumina core, the aluminosilicate coated alumina structure having a surface area from about 150 m²/g to about 600 m²/g, a pore volume from about 0.2 cc/g to about 1.5 cc/g, an average pore diameter from about 1 nm to about 25 nm.

16. The aluminosilicate coated alumina structure of claim 15 comprising less than about 5 ppm of alkaline metal impurities.

17. The aluminosilicate coated alumina structure of claim 15, wherein the aluminosilicate coating has an average thickness (where present) from about 0.1 nm to about 10 nm.

18. The aluminosilicate coated alumina structure of claim 15, wherein at least about 75% of the silicon is in the form of aluminosilicate structure.

19. The aluminosilicate coated alumina structure of claim 15 having a silica content from about 0.25% to about 20% by weight.

20. The aluminosilicate coated alumina structure of claim 15, wherein after thermal aging performed by heating at 1150° C. for 4 hours, the thermally aged aluminosilicate coated alumina structure has a surface area from about 5 m²/g to about 200 m²/g, a pore volume from about 0.2 cc/g to about 1 cc/g, and an average pore diameter from about 5 nm to about 100 nm.

21. The aluminosilicate coated alumina structure of claim 15, wherein silicon atoms are uniformly dispersed in the aluminosilicate coating.

22. A method of treating exhaust gas, comprising:
contacting the exhaust gas with an aluminosilicate coated alumina structure, the aluminosilicate coated alumina structure substantially free of alkaline metal impurities.

23. The method of claim 22, wherein the exhaust gas comprises diesel exhaust gas.

24. The method of claim 22, wherein the exhaust gas comprises one or more of nitrogen oxides, carbon monoxide, gaseous hydrocarbons, and particulate matter.

25. The method of claim 22, wherein the aluminosilicate coated alumina structure supports a catalytically active metal.
